(19) United States
(12) Patent Application Publication
(10) Pub. No.: US 2020/0122970 A1
(43) Pub. Date: Apr. 23, 2020

(54) ELEVATOR SYSTEM AND MULTILAYER CAR FOR AN ELEVATOR SYSTEM

(71) Applicant: Otis Elevator Company, Farmington, CT (US)

(72) Inventor: Alberto Senzo Naruke, Shibayama (JP)

(21) Appl. No.: 16/655,612

(22) Filed: Oct. 17, 2019

(30) Foreign Application Priority Data
Oct. 19, 2018 (CN) 201811221066.8

(51) Int. Cl. B66B 5/28; B66B 5/00

(52) U.S. Cl. CPC B66B 5/28; B66B 2201/306; B66B 5/005

(57) ABSTRACT

An elevator system and a multi-deck car for an elevator system. The elevator system has a multi-deck car that moves up and down along an elevator guide rail in an elevator shaft and comprises a first car and a second car connected to and located below the first car, wherein the second car is provided with a stop-support device configured to be operably engaged with a mating device mounted at a pre-set position on the elevator guide rail and/or the inner wall of the elevator shaft, for stopping and supporting the multi-deck car at the pre-set position upon engaging of the stop-support device and the mating device. The invention not only has advantages of quick and convenient operation, but also can effectively ensure the safety of both elevator equipment and field workers.

### FIELD OF THE INVENTION

The present invention relates to the technical field of elevator, and more particularly to an elevator system and a multi-deck car for an elevator system.

### BACKGROUND

Elevators have been widely used in modern society, bringing great convenience to people's work and daily life. There are lots of various types of elevator installations, equipment or systems in the prior art provided to meet different requirements of applications. For example, an elevator having a double-deck car is shown in FIG. 1. However, these existing elevator installations, equipment or systems still have deficiencies in terms of, for example, convenience of inspection and maintenance, safety, and reliability, which can be further improved and optimized.

### SUMMARY OF THE INVENTION

In view of the foregoing, the present invention provides an elevator system and a multi-deck car for an elevator system so that one or more of the existing problems described above as well as problems of other aspects are resolved or at least relieved.

Firstly, according to the first aspect of the invention, it is provided an elevator system having a multi-deck car that moves up and down along an elevator guide rail in an elevator shaft and comprises a first car and a second car connected to and located below the first car, wherein the second car is provided with a stop-support device configured to be operably engaged with a mating device mounted at a pre-set position on the elevator guide rail and/or the inner wall of the elevator shaft, for stopping and supporting the multi-deck car at the pre-set position upon engaging of the stop-support device and the mating device.

In the elevator system according to the invention, optionally, the elevator system further comprises a control device configured to control engaging or disengaging of the stop-support device and the mating device.

In the elevator system according to the invention, optionally, the control device comprises an electrical switch disposed on the top or inside of the second car.

In the elevator system according to the invention, optionally, the stop-support device comprises one or more chain members, one end of the chain member being mounted on a fixing member on the top of the second car, and the other end of the chain member being configured for operably engaging with the mating device; and/or the stop-support device comprises one or more rod members configured for operably engaging with the mating device, and the mating device is configured as a hole or slot structure.

In the elevator system according to the invention, optionally, the fixing member is a crosshead.

In the elevator system according to the invention, optionally, the multi-deck car further comprises one or more additional cars disposed above the first car and/or below the second car.

Secondly, according to the second aspect of the invention, it is provided a multi-deck car for an elevator system, which moves up and down along an elevator guide rail in an elevator shaft and comprises a first car and a second car connected to and located below the first car, wherein the second car is provided with a stop-support device configured to be operably engaged with a mating device mounted at a pre-set position on the elevator guide rail and/or the inner wall of the elevator shaft, for stopping and supporting the multi-deck car at the pre-set position upon engaging of the stop-support device and the mating device.

In the multi-deck car for an elevator system according to the invention, optionally, the elevator system further comprises a control device configured to control engaging or disengaging of the stop-support device and the mating device.

In the multi-deck car for an elevator system according to the invention, optionally, the control device comprises an electrical switch disposed on top or inside of the second car.

In the multi-deck car for an elevator system according to the invention, optionally, the stop-support device comprises one or more chain members, one end of the chain member being mounted on a fixing member on the top of the second car, and the other end of the chain member being configured for operably engaging with the mating device; and/or the stop-support device comprises one or more rod members configured for operably engaging with the mating device, and the mating device is configured as a hole or slot structure.

In the multi-deck car for an elevator system according to the invention, optionally, the fixing member is a crosshead.

In the multi-deck car for an elevator system according to the invention, optionally, the multi-deck car further comprises one or more additional cars disposed above the first car and/or below the second car.

From the following descriptions in combination with the drawings, one will clearly understand the principles, characteristics, features and advantages of the various technical solutions of the present invention. For example, in comparison with the prior art, the technical solutions of the invention not only have a simpler structure, are easier to manufacture and install, but also do not need field workers to take a component or device such as a stopper pipe from an elevator machine room or the top of an elevator car to stop and park the car. The invention not only has advantage of quick and convenient operation, but also is very safe and reliable, and it can effectively ensure the safety of both elevator equipment and field workers.

### BRIEF DESCRIPTION OF THE DRAWINGS

The technical solutions of the present invention will be further described in detail below in conjunction with the drawings and embodiments. However, it should be understood that the drawings are designed merely for illustrative purpose and are intended only to conceptually explain the configurations described herein. It is unnecessary to draw the drawings in proportion.

FIG. 1 is a partial front elevational view schematically showing the structure of an elevator having a double-deck car in the prior art.

FIG. 2 is a schematic view of using a stopper pipe to stop and park the elevator shown in FIG. 1, in which a stop-support device example in an embodiment of the elevator system in accordance with the present invention is also shown in comparison.

FIG. 3 is a partial perspective view schematically showing a stop-support device example installed in an embodiment of the elevator system in accordance with the present invention.

FIG. 4 is a partial front elevational view schematically showing another stop-support device example installed in an embodiment of the elevator system in accordance with the present invention.

### DETAILED DESCRIPTION OF THE INVENTION

Firstly, it should be noted that the structures, configurations, features, and advantages of the elevator system and the multi-deck car for an elevator system according to the present invention will be described hereinafter by way of examples. None of the descriptions, however, should be construed, in any way, as limiting the scope of the invention. In the present application, the technical terms “first” and “second” are used merely for discriminating purposes and are not intended to indicate their order or relative importance.

Moreover, as for any single technical feature described or implied in the embodiments mentioned herein, or any single technical feature described or implied in the various figures, the present invention still allows any further combination or deletion of these technical features (or equivalents thereof) without any technical difficulty, and therefore it should be considered that more of such embodiments according to the invention are also within the scope of the disclosure contained in the application. In addition, the same or similar components and features may be labeled in only one or several places in the same drawing for the sake of simplicity.

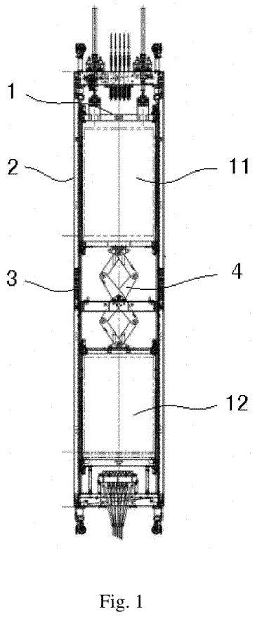

Referring to FIG. 1, a multi-deck car 1 in a current elevator usually receives power provided by, for example, a towing mechanism, and then moves up and down along an elevator guide rail 3 in an elevator shaft 2 so that personnel, cargo, etc. can be carried to the target floor location. When there is a malfunction in the operation of the elevator or if it is desired to perform inspection, maintenance, etc. to the multi-deck car 1, the multi-deck car 1 needs to be parked at a suitable location and a field worker needs to be arranged to enter the site.

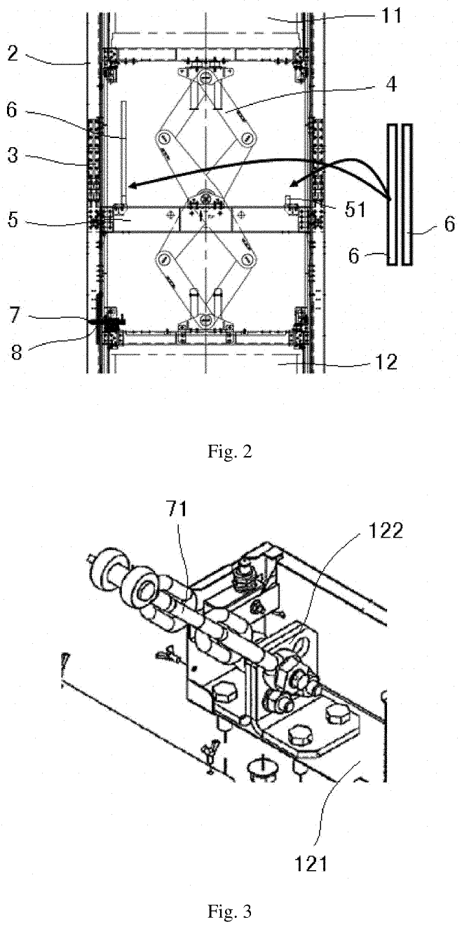

Typically, the field worker has to fetch some stopper devices, such as the two stopper pipes 6 shown in FIG. 2, which are normally stored, for example, in an elevator machine room or on the top of the car or the like. Then, the field worker will use the stopper pipes 6 to operate, i.e. insert them, respectively, into the mating portions 51 of the supporting frame 5 between the cars, thereby holding the multi-deck car 1 in this position.

The inventor of the present invention has found upon study that the intermediate area between the cars of the multi-deck car 1 is actually very limited, and as a result not only it is inconvenient and time-consuming for a field worker to perform the aforementioned operations, but also it easily exposes the worker to undesirable safety risks. Nevertheless, according to the design concept of the invention, it is provided a solution that can stop and park a multi-deck car in a convenient, fast, safe and reliable manner, thereby effectively solving the problems discussed above.

An exemplary description of the improvements will be made below based on the elevator embodiment shown in FIGS. 1 and 2. Specifically, the multi-deck car 1 is provided with two cars, that is, a first car 11 and a second car 12. The second car 12 is disposed below the first car 11, and the two cars may be connected together by a connecting mechanism 4 so that they can move up and down together along the elevator guide rail 3 in the elevator shaft 2.

Distinguishing from the prior art, in the embodiment of the elevator system in accordance with the present invention, a stop-support device 7 is provided on the second car 12. For example, the stop-support device 7 may be arranged on the top or any other suitable location of the second car 12. Then, the multi-deck car 1 can be stopped and held at a pre-set position by operably engaging the stop-support device 7 with the mating device 8 described below. Such a pre-set position may be determined according to the actual application situations. For example, it may be located at the top, bottom, or middle of the elevator shaft 2.

As for the above-mentioned mating device 8, it may be arranged on the elevator guide rail 3 or the inner wall of the elevator shaft 2, or it may be arranged on both the elevator guide rail 3 and the inner wall of the elevator shaft 2. That is to say, the stop-support device 7 will engage with both the elevator guide rail 3 and the elevator shaft 2, which will provide a more favorable and reliable support for the multi-deck car 1.

When a field worker manually operates the stop-support device 7 to engage it with the mating device 8, the relative position between the second car 12, the elevator guide rail 3 and the elevator shaft 2 can be fixed. Namely, the second car 12 and the first car 11 are positioned and held at the pre-set location together, thereby achieving the purpose of stopping and supporting the multi-deck car 1. As a contrast with the prior art, the examples of the above-described stop-support device 7 and the mating device 8 are also schematically illustrated in FIG. 2.

As described above, since in the embodiment of the present invention the stop-support device 7 is directly mounted on the second car 12 for use, a field worker does not need to go to the elevator machine room, the top of the car, etc. to fetch the aforementioned components or devices such as the stopper pipe 6. As a result, it can simplify the operation, save time and efforts, and also avoid initial cumbersome operations in the limited space between the cars as mentioned above which can in turn effectively reduce or avoid potential safety risks.

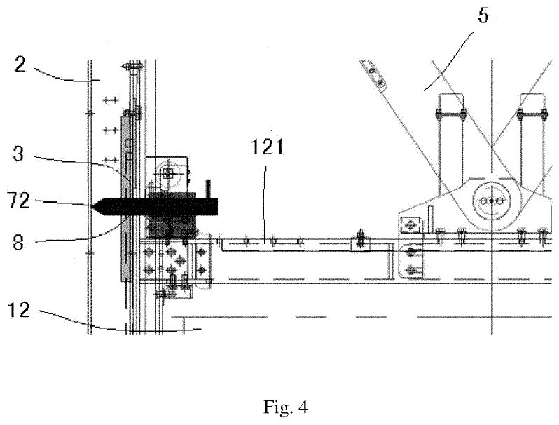

In order to facilitate a better understanding of the technical solutions of the invention, two embodiments of the stop-support device in the elevator system according to the present invention are further illustrated in FIGS. 3 and 4 as exemplary examples.

First, referring to FIG. 3, in this embodiment the stop-support device 7 may be arranged to have one or more chain members 71. The first end of such a chain member 71 may be mounted to a fixing member 122 on the top portion 121 of the second car 12 (e.g., a crosshead or other suitable component attached to the top portion 121), and the second end of the chain member 71 is configured to be suitable for operably engaging with the mating device 8. For example, one of the second end and the mating device 8 may be configured to have a hook-like portion, and the other one may be configured to have a fitting portion for being hooked up with the hook-like portion.

Next, referring to FIG. 4, in this embodiment the stop-support device 7 may be configured to have one or more rod members 72, each of which may be configured for operably engaging with the mating device 8. By way of example, the mating device 8 may be configured as a structure such as a slot so that one or more rod members 72, when needed, can be inserted into such a hole or slot structure to form a secure engagement therebetween. Thereby, a stop-and-support function for the multi-deck car 1 can be achieved.

It should be understood that the invention allows for various possible and flexible selections, changes, and adjustments in terms of the actual amount of arrangement, arrangement position, dimension, and material of the above-described chain member 71 and rod member 72 without departing from the spirit of the present invention. For example, the above-mentioned chain member 71 and rod member 72 may even be simultaneously provided on the second car 12.

Additionally, in some alternative embodiments the invention allows for a further provision of a control device (not shown) for controlling the engagement or disengagement between the stop-support device 7 and the mating device 8 as described above. That is, the engagement or disengagement between the stop-support device 7 and the mating device 8 is not necessarily accomplished by means of a worker's manual operation for the stop-support device 7 as described above.

With respect to such a control device, the engagement or disengagement operation between the support device 7 and the mating device 8 may be achieved by means of, for example, hydraulic pressure, electromagnetic force or the like. Since the prior art has provided a lot of approaches for achieving or changing the engagement/disengagement state between different components or devices by applying hydraulic pressure, electromagnetic force or the like, those skilled in the art are able to fully apply these prior art to effect the engagement or disengagement between the stop-support device 7 and the mating device 8 without departing from the spirit of the present invention. Therefore, these prior art approaches will not be described herein for the sake of brevity.

Optionally, the control device described above may include an electrical switch, wherein the engagement or disengagement between the stop-support device 7 and the mating device 8 may be controlled through manipulation of the electrical switch. Inclusion of the electric switch may prevent a field worker from forgetting to unlock the engagement state after the stop-support device 7 and the mating device 8 have been engaged and then the parking state of the multi-deck car 1 needs to be ended to restore it to a normal operation state. By way of example, the electrical switch described above may optionally be arranged on the top 121 of the second car 12 or inside of the second car 12.

Furthermore, in the elevator system embodiments given above, the multi-deck car 1 is exemplified as having two cars, namely the first car 11 and the second car 12. In actual applications, however, the multi-deck car 1 may be further provided with one or more additional cars, which may be arranged above the first car 11 and/or below the second car 12, so as to meet the needs of various applications better.

According to another aspect of the present invention, it is provided a multi-deck car for an elevator system, so that the outstanding technical advantages provided by the solutions of the invention as described above will be achieved.

By way of example, the multi-deck car according to the present invention may have at least a first car and a second car that is connected to and located below the first car, and they can move up and down along the elevator guide rail in the elevator shaft together. A stop-support device (such as a chain member and/or a rod member) may be provided on the second car, and the multi-deck car can be stopped and supported at a pre-set position by operably engaging the stop-support device with a mating device mounted at the pre-set position on the elevator guide rail and/or the inner wall of the elevator shaft.

Furthermore, the multi-deck car according to the present invention may optionally be further provided with a control device. Further, in addition to the first and second cars described above, the multi-deck car may optionally have one or more additional cars, which may be arranged above the first car and/or below the second car, so as to meet different application requirements better.

It will be understood that since technical contents such as the stop-support device (e.g. chain member, rod member), mating device, control device, electric switch, and pre-set position have already been described in detail hereinbefore with respect to the elevator system designed and provided according to the invention, relevant contents with respect to the multi-deck car according to the invention can be directly referred to the specific descriptions of the corresponding parts in the foregoing, and therefore no repetition is provided herein.

The elevator system and the multi-deck car for an elevator system in accordance with the present invention have been exemplified in detail by way of example only. The examples are merely illustrative of the principles of the invention and its embodiments and are not intended to limit the invention. Various modifications and improvements can be made by those skilled in the art without departing from the spirit and scope of the invention. Therefore, all equivalent technical solutions should be considered and construed to be within the scope of the invention and are defined by the accompanying claims.

What is claimed is:

1. An elevator system, having a multi-deck car that moves up and down along an elevator guide rail in an elevator shaft and comprises a first car and a second car connected to and located below the first car, characterized in that the second car is provided with a stop-support device configured to be operably engaged with a mating device mounted at a pre-set position on the elevator guide rail and/or the inner wall of the elevator shaft, for stopping and supporting the multi-deck car at the pre-set position upon engaging of the stop-support device and the mating device.

2. The elevator system according to claim 1, wherein the elevator system further comprises a control device configured to control engaging or disengaging of the stop-support device and the mating device.

3. The elevator system according to claim 2, wherein the control device comprises an electrical switch disposed on the top or inside of the second car.

4. The elevator system according to claim 1, wherein the stop-support device comprises one or more chain members, one end of the chain member being mounted on a fixing member on the top of the second car, and the other end of the chain member being configured for operably engaging with the mating device; and/or
the stop-support device comprises one or more rod members configured for operably engaging with the mating device, and the mating device is configured as a hole or slot structure.

5. The elevator system according to claim 4, wherein the fixing member is a crosshead.

6. The elevator system according to claim 1 wherein the multi-deck car further comprises one or more additional cars disposed above the first car and/or below the second car.

7. A multi-deck car for an elevator system, which moves up and down along an elevator guide rail in an elevator shaft and comprises a first car and a second car connected to and located below the first car, characterized in that the second car is provided with a stop-support device configured to be operably engaged with a mating device mounted at a pre-set position on the elevator guide rail and/or the inner wall of the elevator shaft, for stopping and supporting the multi-deck car at the pre-set position upon engaging of the stop-support device and the mating device.

8. The multi-deck car according to claim 7, wherein the elevator system further comprises a control device configured to control engaging or disengaging of the stop-support device and the mating device.

9. The multi-deck car according to claim 8, wherein the control device comprises an electrical switch disposed on the top or inside of the second car.

10. The multi-deck car according to claim 7, wherein the stop-support device comprises one or more chain members, one end of the chain member being mounted on a fixing member on the top of the second car, and the other end of the chain member being configured for operably engaging with the mating device; and/or
the stop-support device comprises one or more rod members configured for operably engaging with the mating device, and the mating device is configured as a hole or slot structure.

11. The multi-deck car according to claim 10, wherein the fixing member is a crosshead.

12. The multi-deck car according to claim 7, wherein the multi-deck car further comprises one or more additional cars disposed above the first car and/or below the second car.
